(19) United States
(12) Patent Application Publication
(10) Pub. No.: US 2005/0088977 A1
(43) Pub. Date: Apr. 28, 2005

(54) Dynamic virtual private network (VPN) tunnel quality of service (QoS) treatment

(75) Inventors: Stephane S. Roch, Gatineau (CA); Glenn G. Algie, Ottawa (CA)

Correspondence Address: OGILVY RENAULT, 1981 MCGILL COLLEGE AVENUE, SUITE 1600, MONTREAL, QC, H3A2Y3, CA

(73) Assignee: Nortel Networks Limited

(21) Appl. No.: 09/735,939

(22) Filed: Dec. 14, 2000

(51) Int. Cl. H04L 12/28; H04L 12/56

(52) U.S. Cl. 370/254; 370/401

(57) ABSTRACT

Dynamic Quality of Service (QoS) treatment of traffic within a secure Virtual Private Network (VPN) tunnel is provided by attaching a QoS marker to data traffic at an ingress end of the VPN tunnel. The QoS marker is obtained by querying a policy database. The policy database returns QoS information, from which the QoS marker is derived. The policy data base can be queried by a VPN Gateway at an ingress end of the tunnel during tunnel setup, and/or at any time following tunnel setup to obtain updated QoS information. This updated QoS information is then propagated through the VPN tunnel to a VPN gateway at the opposite end of the VPN Tunnel, so that it can be used for egress processing of the tunnel. traffic without renegotiating the Security Association. Consequently, re-establishment of the tunnel is not required in order to change the QoS treatment of tunnel traffic.

### CROSS-REFERENCE TO RELATED APPLICATIONS

This is the first application filed for the present invention.

### MICROFICHE APPENDIX

Not Applicable.

### TECHNICAL FIELD

The present invention, relates to secure IP-based VPN tunnels, and in particular to a method of providing dynamic quality of service (QoS) treatment of secure virtual private network (VPN) tunnels.

### BACKGROUND OF THE INVENTION

In the modern telecommunications network space, the use of Virtual Private Networks (VPNs) has become increasingly popular as a means enabling cost-effective voice and data communications between remote sites. In general, a VPN is a private data communications network over-laid on a public Internet Protocol (IP) network (e.g. the internet) for connecting corporate data centers, remote offices, mobile employees, telecommuters, customers, suppliers, and business partners. Data transport between remote sites of the VPN is routed through channels which are set up through the public IP network using any of the Point-to-Point Protocol (PPP), Internet Protocol Security (IPSec), Layer 2 forwarding (L2F), and Layer 2 Tunneling Protocol (L2TP) protocols to ensure reliable performance and data security. Under most of these protocols, the data channels supported for use in conveying VPN traffic are referred to tunnels. The IPSec protocol also supports a “transport mode”, which is suitable for end-to-end applications, and not recommended for use in a VPN.

In general, a tunnel encapsulates IP traffic of a communications session within an outer IP header as it passes through the tunnel, and includes: an ingress node at which traffic enters the tunnel and is encapsulated by the addition of the outer IP header; an egress node, where traffic exits the tunnel and is decapsulated by the removal of the outer IP header; and intermediate nodes through which tunneled traffic passes between the ingress and egress. In a VPN environment, the ingress and egress nodes serve as endpoints of an end-to-end communications path, and may correspond to customer premised equipment and/or network-based access equipment provided by an network service provider.

The encapsulation of IP traffic enables various routing and security features, and is a defining characteristic of IP tunnels. In order to simplify the description of the present invention, tunnels are considered to be unidirectional. Bi-directional data transport between two sites on a VPN is achieved by means of two unidirectional tunnels carrying traffic in opposite directions between the two sites. Tunnels may range in complexity from simple IP-in-IP tunnels [see, for example, RFC-2003] to more complex multi-protocol tunnels, such as IP in PPP in L2TP in IPSec transport mode [see, for example, RFC-1661, RFC-2401, and RFC-2661].

IP traffic of a communications session through a tunnel retains its original IP header, while an outer IP header is attached and detached at tunnel endpoints. In general, the intermediate nodes between the tunnel endpoints operate solely on the outer IP header, and hence the per-hop-behavior (PHB) of the tunnel is determined by the contents of the Differentiated Services Code Point (DSCP) field of the outer IP header. The contents of this field is normally negotiated as part of the tunnel set-up procedure,.typically by copying the DSCP field contents of the inner IP header. Once the DSCP field content of the outer IP header has been negotiated, it remains fixed for the life of the tunnel.

However, there are numerous circumstances in which it is desirable to change the PHB of the tunnel, without having to tear down and re-establish the tunnel. For example, a remote client may set up a VPN tunnel to an enterprise LAN in order to open a text communications session. For this purpose, a lower QoS level may be desired in order to reduce costs while retaining acceptable performance for text content. However, while connected to enterprise LAN, the remote client may wish to open a voice over IP (VoIP) or a multimedia session through the tunnel. In order to obtain satisfactory VoIP or multimedia performance, a higher QoS is required. In order to accommodate this requirement, either a second VPN tunnel must be set up between the remote client and the enterprise LAN, or the original tunnel must be set up assuming a maximum QoS requirement.

The former solution produces delays and is inconvenient, particularly if the original tunnel must be torn down before the second tunnel is set up. This may occur if either. the remote client will not support more than one tunnel, or if the enterprise LAN will only support a single tunnel to any one remote client (e.g. for security reasons). If the original tunnel can be retained, then redundant parallel tunnels will be set up, increasing costs. These problems can be alleviated to some extent by the latter solution, in which the original tunnel is set up assuming a level of service appropriate for VoIP or multimedia traffic. However, this solution has the effect of increasing costs while delivering a level of service that is inappropriate to requirements of the original text communications session.

Accordingly a method and apparatus that enables cost-effective use of a secure VPN tunnel, by providing dynamic QoS remains highly desirable. In this respect, the term “dynamic QoS” shall be understood to mean that the QoS treatment applied to data traffic within the VPN tunnel may be changed, at the discretion of either the customer or the service provider, without tearing down and re-establishing the VPN tunnel.

### SUMMARY OF THE INVENTION

On object of the present invention is to provide a method of providing dynamic QoS treatment of data traffic within a secure VPN tunnel.

Accordingly, an aspect of the present invention provides method of providing dynamic QoS treatment of data traffic within a secure VPN tunnel mapped between first and second VPN gateways. A policy database is queried to obtain QoS information concerning a desired QoS treatment for data traffic within the VPN tunnel. The QoS information is forwarded, by the first VPN gateway, through the VPN tunnel to the second VPN gateway. Finally, a QoS marker based on the QoS information is attached to the data traffic within the VPN tunnel by both the first and second VPN gateways.

Another aspect of the present invention provides a VPN gateway adapted to provide dynamic QoS treatment of data traffic within a secure VPN tunnel mapped between the VPN gateway and a second VPN gateway. The VPN gateway includes: means for querying a policy database to obtain QoS information concerning a desired QoS treatment for data traffic within the VPN tunnel; means for forwarding the QoS information through the VPN tunnel to the second VPN gateway; and means for attaching a QoS marker based on the QoS information to the data traffic within the VPN tunnel.

The QoS information obtained from the policy database may comprise the QoS marker corresponding to the desired QoS treatment. Alternatively, the QoS information obtained from the policy database may comprise Tspec and Rspec parameters indicative of the desired QoS treatment. In such cases, the QoS marker may be attached to data traffic within the VPN tunnel by: mapping the Tspec and Rspec parameters to the QoS marker; and inserting the QoS marker into a predetermined field of a header portion of the data traffic within the VPN tunnel.

The QoS marker may be a Differentiated Services Code Point (DSCP) value, which may be obtained directly from the QoS information obtained from the policy database, or derived from the QoS information obtained from the policy database.

In embodiments of the invention, an indication of a desired QoS treatment is obtained from a customer. An availability of the desired QoS treatment is then confirmed. If the desired QoS treatment is available, the policy database is updated with information respecting the desired QoS treatment.

The availability of the desired QoS treatment may be confirmed by any one or more of: determining whether or not the VPN tunnel has sufficient available bandwidth to support the desired QoS; and comparing the desired QoS to a Service Level Agreement (SLA).

The policy database may be queried at a start of the communications session. In such cases, the policy database may be queried in response to a session initiation message received from the customer.

Alternatively, the policy database may be queried during the communications session. In such cases, the policy database may be queried at predetermined intervals during the communications session. The policy database may also be queried in response to a query request from either one of the customer and a service provider. A further alternative is to query the policy database in response to a change in the information respecting QoS treatment stored in the policy database.

In embodiments of the invention, a service provider is notified of the indicated QoS treatment. The service provider may be notified at a start of the communications session, or alternatively in response to a change in the indicated QoS treatment.

In summary, dynamic Quality of Service (QoS) treatment of data traffic within a secure Virtual Private Network (VPN) tunnel is provided by attaching a QoS marker to data traffic at an ingress end of the VPN tunnel. The QoS marker, which may be a DSCP value, is obtained by querying a policy database. The policy database returns QoS information, such as a DSCP value and/or a set of Tspec and Rspec parameters, from which the QoS marker is derived. The policy data base can be queried by a VPN Gateway at an ingress end of the tunnel during tunnel setup, and/or at any time following tunnel setup to obtain updated QoS information. This updated QoS information is then propagated through the VPN tunnel to a VPN gateway at the opposite end of the VPN Tunnel, so that it can be used for egress processing of the tunnel traffic. Because the updated QoS information is exchanged between the VPN gateways supporting the VPN tunnel within the existing tunnel Security Association, the VPN gateways are able to utilize the updated QoS information for processing VPN traffic without renegotiating the Security Association. As a result, dissolution and re-establishment of the tunnel is not required in order to change the QoS treatment of tunnel traffic. The QoS information within the policy database can be updated by either a subscriber or a network service provider, independently of operation of the VPN tunnel.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating exemplary elements in a network in which the present invention may be deployed; and

FIG. 2 is a message flow diagram schematically illustrating principle messages exchanged between the elements of the network of FIG. 1 for implementing dynamic QoS treatment in accordance with an embodiment of the present invention.

It will be noted that throughout the appended drawings, like features are identified by like reference numerals.

### DETAILED DESCRIPTION OF THE PREFERRED EMBODIMENT

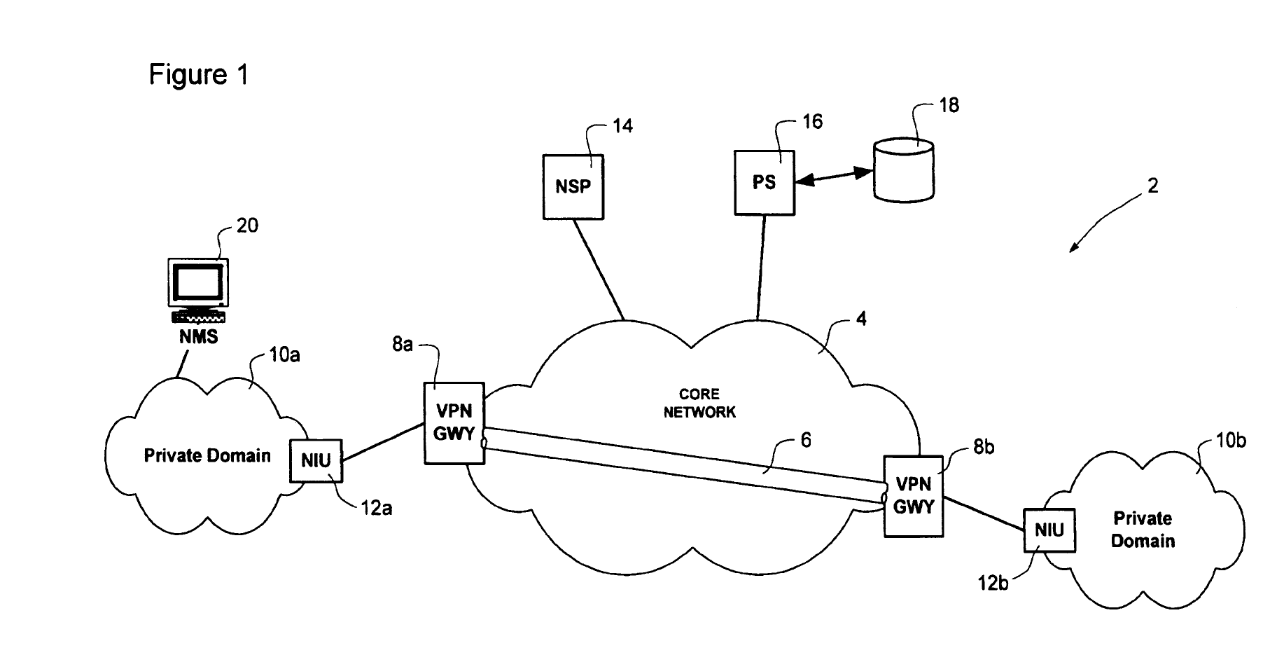

The present invention provides a method and apparatus for enabling dynamic QoS treatment of traffic transported across an IP network through a VPN tunnel. FIG. 1 is a block diagram schematically illustrating exemplary elements in a network in which the present invention may be deployed.

As shown in FIG. 1, the network 2 (which may, for example, be the public internet) generally comprises a network core 4 through which a VPN tunnel 6 may be mapped between a pair of VPN gateway nodes 8a and 8b. In the illustrated embodiment, a pair of private domains 10a,10b are connected to respective ones of the VPN gateways 8a,8b via a respective network interface unit 12a,12b. Thus, secure IP traffic may be routed through the VPN tunnel 6 between the private domains 10a,10b via the network interface units 12a,12b and the VPN gateways 8a,8b. Each of the private domains 10a and 10b may be provided as any one of: a stand-alone personal computer (PC), or notebook computer; or a secure domain such as an enterprise LAN or WAN.

As is known in the art, VPN services across the core network 4 are provided by a network service provider which provides subscribers in each of the private domains 10a,10b with access to the VPN gateways 8a,8b and authorization to set up VPN tunnels 6 in accordance with predetermined service level agreements. For this purpose, the network service provider may deploy one or more NSP servers 14 providing subscriber log-on, authentication, and account services, as well as one or more policy servers 16 for accessing subscriber policy information stored in a policy database 18. The private domains 10a,10b are typically provided with means (either hardware and/or software) enabling a subscriber to access the NSP server 14 in order to enable the subscriber to access their account information and perform various network management functions such as, for example, obtaining network usage, auditing and billing information. In the illustrated embodiment, the private domain 10a includes a network management system 20 (which may be deployed as any suitable combination of hardware and/or software) for this purpose.

Typically, the VPN tunnel 6 is set up using QoS parameters stored in the policy database 18 in accordance with a service level agreement negotiated between the subscriber and the network service provider. Once the VPN tunnel 6 has been set up, the per-hop behavior of network nodes (not shown) transited by the VPN tunnel 6 between the two VPN gateways 8a,8b is determined by the differentiated services code point (DSCP) of the outer IP header attached to tunnel traffic by the ingress VPN gateway 8a. Frequently, the DSCP of the outer IP header is a copy of the DSCP of the tunnel traffic originating in the associated private domain 10. Because the IPSec protocol does not incorporate negotiation of the QoS treatment as part of the security association established during tunnel set up by the VPN gateways 8a,8b, in the event of that a subscriber wishes to alter the QoS treatment of traffic within the tunnel, it is not possible to renegotiate the security association (with QoS changes) between the VPN gateways 8a and 8b. Consequently, re-negotiation of the security association requires that the VPN tunnel 6 be dismantled and replaced by a new VPN tunnel 6 which is set up using the new QoS requirements of the subscriber. The present invention overcomes this difficulty by providing a method and apparatus by which the QoS treatment of traffic within a VPN tunnel 6 may be changed without dismantling and rebuilding the VPN tunnel 6. Thus, in accordance with the present invention, the QoS treatment of tunnel traffic is determined by the contents of the DSCP field of the outer IP header assigned by the ingress VPN gateway 8. However, rather than being copied from the inner IP header, this value is determined by the policy server 16 based on policy information respecting the subscriber stored in the policy database 18. Thus, for example, the VPN gateway 8a is enabled to obtain an appropriate DSCP value by querying the policy server 16. Querying of the policy server 16 in this manner can be performed during set up of the VPN tunnel 6, and thereafter from time to time as required (e.g. in response to a “re-query” message received from either one of the NSP server 14 or the subscriber's network management system 20). In the event of a change of the DSCP value, the VPN gateway 8a can propagate the new DSCP value through the VPN tunnel 6 to the opposite end VPN gateway 8b to thereby ensure proper handling of packets including the new DSCP value. The two VPN gateways 8a and 8b at opposite ends of the VPN tunnel 6 can thereafter continue processing tunnel traffic on the basis of the new DSCP value. Because the VPN gateway 8a forwards the new DSCP value through the VPN gateway 6, it's transmission between the two VPN gateways 8a and 8b is accomplished under the previously negotiated security association. Accordingly, the conventional IPSec authentication and validation routines do not need to be re-negotiated, and thus it is possible for the two VPN gateways 8a and 8b to utilize the new DSCP value without re-negotiating the security association.

In order to facilitate transmission of the new DSCP value through the VPN tunnel 6 between the VPN gateway 8a and the opposite end VPN gateway 8b, it is convenient to define an extension to the ISAKMP/IKE protocol. In particular, a new ISAKMP/IKE message may be defined as a “policy” update message identified by a respective “next payload” type. Under conventional ISAKMP/IKE protocol, 14 next payload types are defined (identified by next payload field values of 0 through 12), whereas next field values 14 through 127 are reserved. Thus, it is possible to define an ISAKMP/IKE policy update message in which the next payload field contains a value corresponding to one of the conventionally reserved values. The payload of the ISAKMP/IKE policy update message contains the updated QoS treatment parameters which may, in principle, take any convenient form, such as the new DSCP value or a set of RSVP t-spec and r-spec parameters which can be mapped to the new DSCP value in a manner known in the art.

In addition, a messaging framework is preferably provided to enable interaction between the (or each) VPN gateway 8 and the policy server 16, and further to enable a subscriber to request QoS changes. Thus, for example, each VPN gateway 8 may be provided with a COPS-PR interface to facilitate messaging with the policy server 16, and thereby enable functionality respecting authorization of subscriber initiated QoS change requests; and translation of TSpec and RSpec QoS information into QoS markers (e.g. DSCP bits) for insertion into the tunnel traffic. Each VPN gateway 8 may also be provided with an RSVP interface to facilitate messaging with the subscriber's NMS 20 (either directly or via the subscriber's network service provider 14), and thereby enable reception of (and responses to) subscriber-originated QoS change requests.

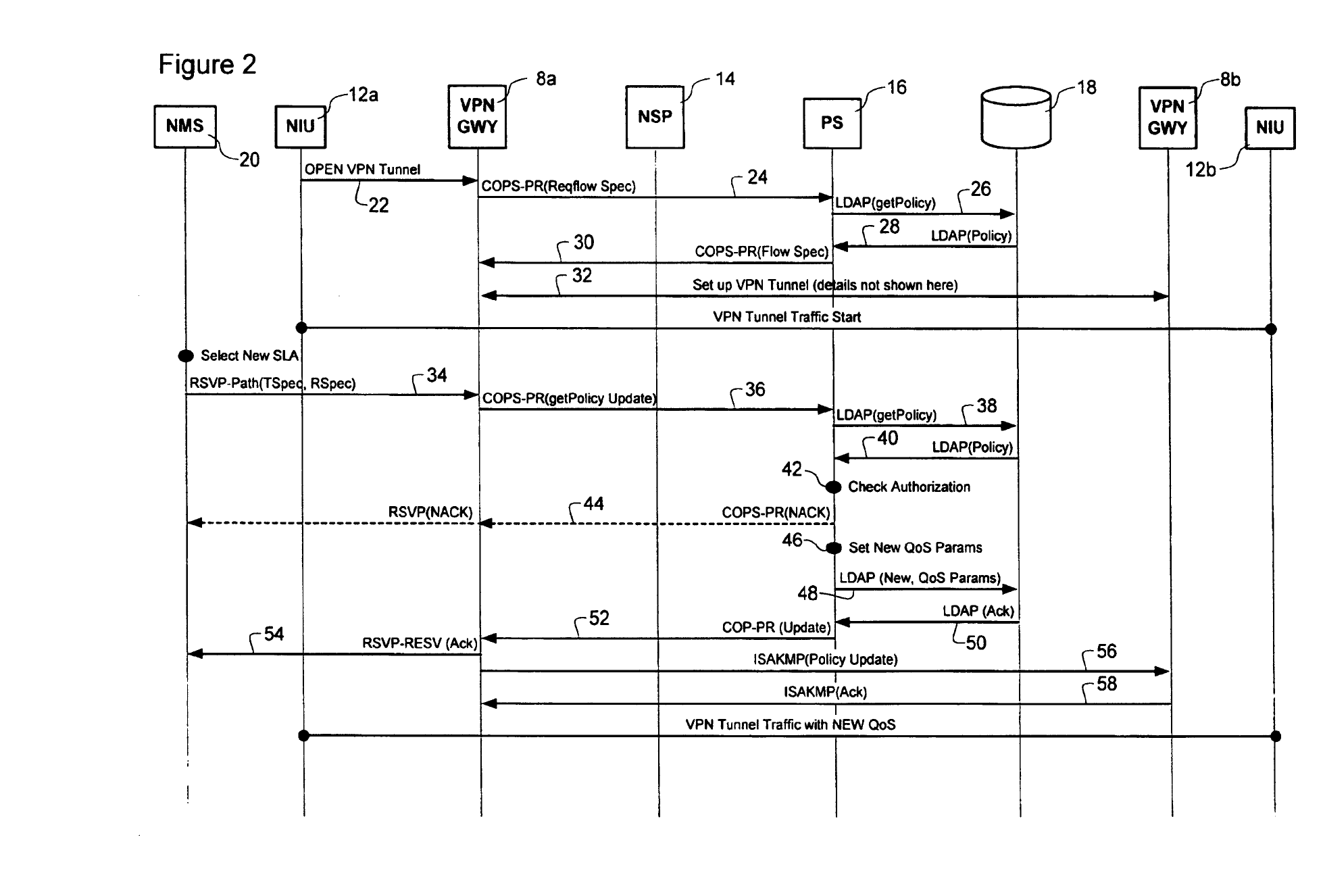

FIG. 2 is a message flow diagram illustrating principle messages exchanged between elements of the network of FIG. 1 in an exemplary method for implementing the dynamic QoS within the VPN tunnel 6 in accordance with the present invention. Thus, the private domain 10a forwards an “open tunnel” message 22 to the VPN gateway 8a in order to initiate the set up of the VPN tunnel 6. In order to obtain the QoS parameters for the VPN tunnel 6, the VPN tunnel 8a launches a policy request message 24 to the policy server 16, which, in turn queries the policy database 18 (at steps 26 and 28) to obtain respective policy information concerning the subscriber. Upon receipt of the subscriber's policy information from the policy database 18, the policy server 16 extracts and forwards the appropriate QoS parameters (at step 30) to the VPN gateway 8a. Based on the received QoS parameters, the VPN gateway 8a proceeds to negotiate a service association with the VPN gateway 8b and set up the VPN tunnel 6 (at step 32) in a conventional manner. Following set up of the VPN tunnel 6 secure IP traffic can flow through the VPN tunnel 6 between the private domains 10a and 10b. As shown in FIG. 2, messaging between the VPN gateway 8a and the policy server 16 may conveniently be accomplished using conventional COPS-PR signaling. Similarly, the policy server 16 may conveniently query the policy database using LDAP messaging. However, it will be appreciated that, in both cases, other messaging protocols may equally be utilized for these purposes. Messaging between the VPN gateways 8a and 8b to accomplish the set up of the VPN tunnel 6 may be accomplished in a conventional manner using ISAKMP/IKE messaging.

Once the VPN tunnel 6 has been set up (as discussed above at steps 22 through 32), IP traffic originating within the private domain 10a is encapsulated, by the VPN gateway 8a, within an outer IP header for transport through the VPN tunnel 6 to the opposite end VPN gateway 8b, which strips the outer IP header before forwarding the IP traffic to the private domain 10b. The outer IP header attached by the VPN gateway 8a is prepared in a substantially conventional manner, with the exception that the value of the DSCP field of the outer IP header is derived from the QoS parameters obtained from the policy server 16 (at step 30 above), rather than being copied from the DSCP field of the inner IP header.

Following establishment of the VPN tunnel 6, the subscriber may desire to change the QoS treatment of the IP traffic through the tunnel 6. In order to accomplish this, the subscriber uses the network management system 20 to forward a New SLA message (at step 34) to the VPN gateway 8a (possibly via the NSP server 14) in order to request a change in the service level agreement. The VPN gateway 8a forwards the requested new SLA parameters to the policy server 16 (at step 36) which queries the policy database (at step 38) to obtain policy information respecting the subscriber (at step 40). Upon receipt of the policy information, the policy server 16 determines an authorization of the subscriber to obtain the requested new QoS treatment (at step 42). This authorization check may include comparing the requested QoS treatment with predetermined service level guarantees, billing plans and/or subscriber billing limits. The authorization check may also include querying the VPN gateway 8a to determine whether or not sufficient bandwidth capacity exists within the VPN tunnel 6 to accept the requested QoS treatment. If the authorization checks fail, the policy server 16 forwards an appropriate message (at step 44) back to the network management system 20, via the VPN gateway 8a (and possibly the NSP server 14) to advise the subscriber that the requested QoS treatment is not available. On the other hand, if the authorization checks at step 42 are successfully completed, the policy server sets new QoS parameters (at step 46) which are saved as part of the subscriber profile in the profile database 18 (at steps 48 and 50). The policy server 16 then forwards an acknowledgement message (step 52) to the VPN gateway 8a to indicate that the requested new QoS treatment has been accepted and the QoS parameters saved in the policy database 18 successfully updated. Consequently, the VPN gateway 8a forwards an acknowledgement message (at step 54) to the NMS 20 to advise the subscriber that the requested new QoS treatment has been accepted. The VPN gateway 8a then prepares an ISAKMP/IKE policy update message containing the updated QoS parameters, and forwards the policy update message (at step 56) to the VPN gateway 8b through the VPN tunnel 6. Secure transfer of the updated QoS parameters is ensured, because the ISAKMP/IKE policy update message is conveyed through the VPN tunnel under the existing security association. Following receipt of the ISAKMP/IKE policy update message, the VPN gateway 8b extracts the new QoS parameters for use in processing VPN tunnel traffic, before returning an ISAKMP acknowledgment message (at step 58) to the VPN tunnel 8a. Thereafter, both the VPN gateways 8a,8b continue processing IP traffic through the VPN tunnel 6 utilizing the new QoS parameters for determining the value of the DSCP field of the outer IP header.

Thus it will be seen that the present invention provides a method an apparatus enabling dynamic QoS treatment of secure VPN tunnel traffic. Cost-effective use of secure VPN tunnels is therefore enabled by allowing QoS treatment to be varied according to the requirements of the user.

The embodiment(s) of the invention described above is(are) intended to be exemplary only. The scope of the invention is therefore intended to be limited solely by the scope of the appended claims.

1. A method of providing dynamic Quality of Service (QoS) treatment of data traffic within a secure Virtual Private Network (VPN) tunnel, the method comprising the steps of:
a) querying a policy database to obtain QoS information concerning a desired QoS treatment for data traffic within the VPN tunnel;
b) forwarding the QoS information through the VPN tunnel to a VPN gateway at an opposite end of the VPN Tunnel; and
c) attaching a QoS marker based on the QoS information to the data traffic within the VPN tunnel.

2. A method as claimed in claim 1, wherein the QoS information obtained from the policy database comprises the QoS marker.

3. A method as claimed in claim 1, wherein the QoS information obtained from the policy database comprises Tspec and Rspec parameters indicative of the desired QoS treatment.

4. A method as claimed in claim 3, wherein the step of attaching a QoS marker comprises the steps of:
a) mapping the Tspec and Rspec parameters to the QoS marker; and
b) inserting the QoS marker into a predetermined field of a header portion of the data traffic within the VPN tunnel.

5. A method as claimed in claim 4, wherein the QoS marker is a Differentiated Services Code Point (DSCP) value.

6. A method as claimed in claim 1, wherein the step of obtaining an indication of a QoS treatment further comprises the steps of:
a) obtaining, from a customer, an indication of a desired QoS treatment;
b) confirming an availability of the desired QoS treatment; and
c) if the desired QoS treatment is available, updating the policy database with information respecting the desired QoS treatment.

7. A method as claimed in claim 6, wherein the step of confirming an availability of the desired QoS treatment comprises any one or more of the steps of:
a) determining whether or not the VPN tunnel has sufficient available bandwidth to support the desired QoS; and
b) comparing the desired QoS to a Service Level Agreement (SLA).

8. A method as claimed in claim 1, wherein the step of querying the policy database is performed at a start of the communications session.

9. A method as claimed in claim 8, wherein the step of querying the policy database is performed in response to a session initiation message received from the customer.

10. A method as claimed in claim 1, wherein the step of querying the policy database is performed during the communications session.

11. A method as claimed in claim 10, wherein the step of querying the policy database is performed at predetermined intervals during the communications session.

12. A method as claimed in claim 10, wherein the step of querying the policy database is performed in response to a query request from either one of the customer and a service provider.

13. A method as claimed in claim 10, wherein the step of querying the policy database is performed in response to a change in the information respecting QoS treatment stored in the policy database.

14. A method as claimed in claim 1, further comprising a step of notifying a service provider of the indicated QoS treatment.

15. A method as claimed in claim 14, wherein the step of notifying the service provider is performed at a start of the communications session.

16. A method as claimed in claim 14, wherein the step of notifying the service provider is performed in response to a change in the indicated QoS treatment.

17. A VPN gateway adapted to provide dynamic QoS treatment of data traffic within a secure VPN tunnel, the gateway comprising:
a) means for querying a policy database to obtain Qos information concerning a desired Qos treatment for data traffic within the VPN tunnel;
b) means for forwarding the QoS information through the VPN tunnel to a VPN gateway at an opposite end of the VPN Tunnel; and
c) means for attaching a QoS marker based on the QoS information to the data traffic within the VPN tunnel.

18. A VPN gateway as claimed in claim 17, wherein the QoS information obtained from the policy database comprises the QoS marker.

19. A VPN gateway as claimed in claim 17, wherein the QoS information obtained from the policy database comprises Tspec and Rspec parameters indicative of the desired QoS treatment.

20. A VPN gateway as claimed in claim 19, wherein the means for attaching a QoS marker comprises:
a) means for mapping the Tspec and Rspec parameters to the QoS marker; and
b) means for inserting the QoS marker into a predetermined field of a header portion of the data traffic within the VPN tunnel.

21. A VPN gateway as claimed in claim 20, wherein the QoS marker is a Differentiated Services Code Point (DSCP) value.

22. A VPN gateway as claimed in claim 17, further comprising means for receiving a QoS request message indicative of the desired QoS treatment.

23. A VPN gateway as claimed in claim 17, wherein the means for forwarding the QoS information through the VPN tunnel comprises:
a) a policy update message adapted to convey the QoS information through the VPN tunnel; and
b) means for inserting the QoS information into a payload portion of the policy update message.

24. A VPN gateway as claimed in claim 23, wherein the policy update message is an ISAKMP/IKE message having a predetermined unique “Next Payload” type.

25. A VPN gateway as claimed in claim 17, wherein the policy database is queried at a start of the communications session.

26. A VPN gateway as claimed in claim 25, wherein the means for querying the policy database is responsive to a session initiation message received from the customer.

27. A VPN gateway as claimed in claim 17, wherein the policy database is queried during the communications session.

28. A VPN gateway as claimed in claim 27, wherein the policy database is queried at predetermined intervals during the communications session.

29. A VPN gateway as claimed in claim 27, wherein the means for querying the policy database is responsive to a query request from either one of the customer and a service provider.

30. A VPN gateway as claimed in claim 27, wherein the means for querying the policy database is responsive to a change in the information respecting QoS treatment stored in the policy database.

31. A VPN gateway as claimed in claim 17, further comprising means for notifying a service provider of the indicated QoS treatment.

32. A VPN gateway as claimed in claim 31, wherein the means for notifying the service provider is adapted to send a notification message to the service provider at a start of the communications session.

33. A VPN gateway as claimed in claim 31, wherein the means for notifying the service provider is adapted to send a notification message to the service provider in response to a change in the indicated QoS treatment.
